(19) United States
(12) Patent Application Publication
(10) Pub. No.: US 2025/0176644 A1
(43) Pub. Date: Jun. 5, 2025

(54) AEROSOL PROVISION DEVICE

(71) Applicant: NICOVENTURES TRADING LIMITED, London (GB)

(72) Inventors: Mark POTTER, London (GB); David Alan NELSON, London (GB); Ross CABOT, London (GB); Matthew HODGSON, London (GB); Juan Esteban PAZ JAUREGUI, London (GB); David LINTERN, London (GB); Andrew DENLEY, London (GB)

(21) Appl. No.: 18/841,036

(22) PCT Filed: Feb. 24, 2023
(86) PCT No.: PCT/EP2023/054741

§ 371 Date: Aug. 23, 2024

(30) Foreign Application Priority Data
Feb. 25, 2022 (GB) 2202656.1

(51) Int. Cl. A24F 40/85; A24F 40/465; A24F 40/53; A24F 40/60

(52) U.S. Cl. CPC A24F 40/85; A24F 40/465; A24F 40/53; A24F 40/60

(57) ABSTRACT

An aerosol provision device including an aerosol generator and a first device arranged to determine a cleanliness state or a predicted cleanliness state of a first surface located within the aerosol provision device.

### RELATED APPLICATIONS

The present application is a National Phase entry of PCT Application No. PCT/EP2023/054741 filed Feb. 24, 2023, which claims priority to GB Application No. 2202656.1 filed Feb. 25, 2022, each of which is hereby incorporated by reference in their entirety.

### TECHNICAL FIELD

The present invention relates to an aerosol provision device, an aerosol generating system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Conventional aerosol provision devices comprise a cylindrical heating chamber into which a rod shaped consumable is inserted.

Next generation devices are contemplated wherein a consumable having a shape other than cylindrical is used, such as a consumable comprising a planar substrate. The planar substrate may comprise a susceptor to be heated by penetration with a varying magnetic field. For example, the planar substrate may comprise a card base layer having an aluminum foil layer adhered thereto. The aluminum foil layer may act as a susceptor. An aerosol generating material (i.e. gel) may be provided upon the aluminum foil layer (susceptor). The planar substrate may be inserted into an aerosol provision device and may be translated or rotated relative to a heating element.

### SUMMARY

According to an aspect there is provided an aerosol provision device comprising:
an aerosol generator; and
a first device arranged to determine a cleanliness state or a predicted cleanliness state of a first surface located within the aerosol provision device.

According to various arrangement an aerosol provision device may be provided wherein the aerosol provision device comprises an inductive heating element. A first (i.e. contact) surface may be provided between a portion of the aerosol provision device and an aerosol generating article when inserted into the aerosol provision device during use. As a result, the first (i.e. contact) surface may become dirty over a period of time. According to various embodiments an aerosol provision device is provided having a first device which is arranged to determine a cleanliness state or a predicted cleanliness state of the first (i.e. contact) surface.

Optionally, the aerosol generator comprises one or more induction coils or inductive heating elements.

Optionally, the first surface comprises a contact surface between an aerosol generating article and the aerosol provision device.

Optionally, the first surface comprises a surface of an isolation layer or a first layer.

Optionally, the isolation layer or first layer comprises a thermal isolation layer.

Optionally, the isolation layer or first layer comprises glass, ceramic or a plastic layer.

Optionally, the isolation layer or first layer is optically transparent.

Optionally, the isolation layer or first layer has a thermal conductivity of <0.01 W/mK, 0.01-0.05 W/mK, 0.05-0.1 W/mK, 0.1-0.5 W/mK, 0.5-1 W/mK, 1-5 W/mK, 5-10 W/mK, 10-20 W/mK, 20-30 W/mK, 30-40 W/mK or 40-50 W/mK.

Optionally, the isolation layer or first layer is magnetically transparent.

Optionally, the first device comprises a controller or a processor.

Optionally, the first device is arranged to determine: (i) the number of puffs taken by a user subsequent to a prior cleaning event; (ii) the number of activations of the aerosol generator subsequent to a prior cleaning event; or (iii) the number of rotations or translations of an aerosol generating article subsequent to a prior cleaning event.

Optionally, the first device is arranged to determine a distance or separation between a portion of the aerosol generator and a portion of an aerosol generating article located, in use, within the aerosol provision device.

Optionally, the first device is arranged to determine whether a ramp up time corresponding to the time taken to reach an operational temperature has increased above a threshold time.

Optionally, if the first device determines that a ramp up time has increased above a threshold time then the first device is arranged to determine that the first surface has a first cleanliness state.

Optionally, if the first device determines that a ramp up time has not increased above a threshold time then the first device is arranged to determine that the first surface has a second cleanliness state.

Optionally, the first surface comprises a surface of a planar optical waveguide.

Optionally, the planar optical waveguide comprises an entrance face, a waveguiding portion having a longitudinal direction and an exit face, wherein the entrance face and/or the exit face are arranged in a plane which is orthogonal to the longitudinal direction.

Optionally, the aerosol provision device further comprises an optical transmitter arranged to transmit electromagnetic radiation into the optical waveguide and an optical detector arranged to detect electromagnetic radiation emerging from the optical waveguide.

Optionally, the aerosol provision device further comprises a processor arranged to determine an internal reflectance angle or critical angle of the planar optical waveguide and wherein the first device is arranged to determine a cleanliness state or a predicted cleanliness state of the surface based upon the determined internal reflectance angle or critical angle.

Optionally, the aerosol provision device further comprises an optical transmitter and an optical detector, wherein the optical transmitter is arranged to emit electromagnetic radiation which is either reflected by the first surface or which is transmitted through the first surface and wherein the optical detector is arranged to detect the electromagnetic radiation reflected by or transmitted through the first surface.

Optionally, the aerosol provision device further comprises a layer having one or more optical markings and an optical device which is arranged to view or interrogate the one or more optical markings, wherein the first surface comprises a surface of the layer having one or more optical markings.

Optionally, the aerosol provision device further comprises an optical device which is arranged to view or interrogate a barcode, QR code or other optical marking provided on an aerosol generating article.

Optionally, the optical device is arranged to output a signal to the first device and wherein the first device is arranged to determine a cleanliness state or a predicted cleanliness state of the first surface based upon the signal output from the optical device.

Optionally, the first device comprises an imaging device for observing and analyzing an image provided on a component of the aerosol provision device and/or an aerosol generating article, wherein the first device is arranged to determine a cleanliness state of the surface dependent upon analysis of one or more qualities of the image as observed.

Optionally, the aerosol provision device further comprises a heater or other cleaning device for cleaning the first surface.

Optionally, if the first device determines that the first surface has a cleanliness state or a predicted cleanliness state above or below a threshold then the first device is arranged to activate the heater or other cleaning device in order to clean the first surface.

Optionally, if the first device determines that the first surface has a cleanliness state or a predicted cleanliness state above or below a threshold then the first device is arranged to activate the heater to perform a heating cycle in order to clean the first surface by maintaining the first surface at a temperature of T° C. for at least a time t1 prior to, during or after a session of use, wherein optionally T is in the range <50° C., 50-100° C., 100-150° C., 150-200° C., 200-250° C., 250-300° C. or >300° C. and wherein optionally t1 is in the range <30 s, 30-60 s, 60-90 s, 90-120 s or >120 s.

Optionally, the aerosol provision device further comprises a device arranged to inform a user of the cleanliness state or predicted cleanliness state as determined by the first device. The device arranged to inform a user of the cleanliness state or predicted cleanliness state may be an indicator.

Optionally, the aerosol provision device further comprises a device arranged to advise a user to perform a cleaning routine if the first device determines that the surface has a first cleanliness state.

Optionally, the first device comprises one or more resistive, capacitive or inductive sensors.

According to another aspect there is provided an aerosol generating system comprising:
an aerosol provision device as described above; and
an aerosol generating article.

Optionally, the aerosol generating article comprises: (i) a substantially circular, oval or polyhedral substrate having one or more portions of aerosol generating material arranged on a first surface of the substrate and/or one or more portions of aerosol generating material arranged on a second surface of the substrate; (ii) a substantially planar substrate having one or more portions of aerosol generating material arranged on a first surface of the substrate and/or one or more portions of aerosol generating material arranged on a second surface of the substrate; or (iii) a prismatic or cylindrical shaped aerosol generating article.

Optionally, the aerosol generating article comprises either an open type consumable or a closed type consumable.

According to another aspect there is provided a method of generating an aerosol comprising:
providing an aerosol provision device comprising an aerosol generator; and
determining a cleanliness state or a predicted cleanliness state of a first surface located within the aerosol provision device.

### BRIEF DESCRIPTION OF THE DRAWINGS

Various embodiments will now be described, by way of example only, and with reference to the accompanying drawings, in which:

FIG. 1 shows a cross-section of a schematic representation of an aerosol provision device and an aerosol generating article, the aerosol provision device comprising a plurality of induction coils and the aerosol generating article comprising a plurality of portions of aerosol generating material and corresponding susceptor portions;

FIG. 2 shows an aerosol provision device in combination with an aerosol generating article, wherein the aerosol generating article comprises a plurality of portions of aerosol generating material and wherein the aerosol provision device comprises a single inductive heating element and a movement mechanism for rotating the aerosol generating article relative to the single inductive heating element;

FIG. 3A shows a plan view of an aerosol generating article, FIG. 3B shows an end-on view of the aerosol generating article and shows a plurality of susceptors embedded into the aerosol generating article and FIG. 3C shows a side view of the aerosol generating article and shows a plurality of susceptors embedded into the aerosol generating article;

FIG. 4A shows a perspective view of an aerosol provision device wherein a slidable clasp is used to secure a first or upper lid portion of the aerosol provision device having a mouthpiece to a second or lower base portion, FIG. 4B shows a perspective view with the slidable clasp removed and FIG. 4C shows a perspective view showing the lid of the aerosol provision device open and an aerosol generating article inserted into the aerosol provision device;

FIG. 5 shows components of a portion of an aerosol provision device wherein an isolation layer or first layer is provided above an induction coil so as to interface with an aerosol generating article;

FIG. 6 shows a close up cutaway view of a portion of an aerosol generating article showing an isolation layer or first layer provided between an induction coil and an aerosol generating article;

FIG. 7 shows a portion of an aerosol provision device according to an embodiment wherein the cleanliness of an isolation layer or first layer is determined by emitting electromagnetic radiation from an optical transmitter, passing the electromagnetic radiation through the isolation layer or first layer which forms an optical waveguide and detecting the electromagnetic radiation which emerges from the optical waveguide using an optical receiver;

FIG. 8 shows another arrangement wherein the cleanliness of an isolation layer or first layer is determined by reflecting electromagnetic radiation off a first or upper surface of the isolation layer or first layer;

FIG. 9 shows another arrangement wherein the cleanliness of an isolation layer or first layer is determined by transmitting electromagnetic radiation through the isolation layer or first layer in a direction orthogonal to the plane of the isolation layer or first layer;

FIG. 10 shows another arrangement wherein the cleanliness of an isolation layer or first layer is determined by using an imaging device to view optical markings provided in or on an isolation layer or first layer; and

FIG. 11 shows a further arrangement wherein if the cleanliness of an isolation layer or first layer is determined to be relatively poor then a heater may be operated in order to heat the isolation layer or first layer in order to clean the surface of the isolation layer or first layer.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be an aerosol-generating film. The aerosol-generating film may be formed by combining a binder, such as a gelling agent, with a solvent, such as water, an aerosol-former and one or more other components, such as active substances, to form a slurry and then heating the slurry to volatilize at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating film may comprise or be a sheet, which may optionally be shredded to form a shredded sheet.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents and when such eddy currents are generated in the object, their flow against the electrical resistance of the object causes the object to be heated. This process is called Joule, ohmic or resistive heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

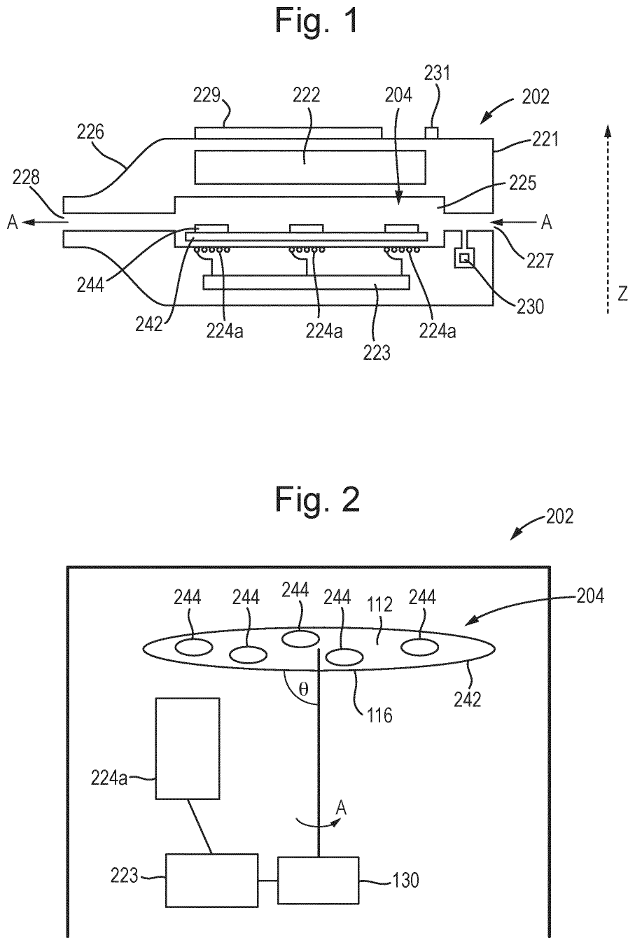

FIG. 1 shows an aerosol provision device 202 according to an arrangement which may comprise a lid portion, a base portion and a securing portion.

According to various embodiments an isolation layer, which may comprise a thermal isolation layer, may be provided above one or more induction heating elements 224a. The isolation layer is not shown in FIG. 1 for clarity purposes. According to various embodiments a first device may be arranged to determine a cleanliness state or a predicted cleanliness state of a surface of the isolation layer. The first device may comprise one or more resistive, capacitive or inductive sensors.

The aerosol provision device 202 may comprise an outer housing 221 which may be formed from any suitable material, for example a plastics material. The outer housing 221 may be arranged such that the power source 222, control circuitry 223, one or more induction coils 224a, reception region 225 and inhalation sensor 230 are located within the outer housing 221. The outer housing 221 also defines the air inlet 227 and air outlet 228. A touch sensitive panel 229 and an end of use indicator 231 may be located on the exterior of the outer housing 221.

The outer housing 221 may further include a mouthpiece end 226. The outer housing 221 and mouthpiece end 226 may be formed as a single component (that is, the mouthpiece end 226 may form a part of the outer housing 221). The mouthpiece end 226 is defined as a region of the outer housing 221 which includes the air outlet 228 and is shaped in such a way that a user may comfortably place their lips around the mouthpiece end 226 to engage with air outlet 228.

The thickness of the outer housing 221 may decrease towards the air outlet 228 to provide a relatively thinner portion of the aerosol provision device 202 which may be more easily accommodated by the lips of a user.

The power source 222 may be configured to provide operating power to the aerosol provision device 202. The power source 222 may comprise any suitable power source, such as a battery. For example, the power source 222 may comprise a rechargeable battery, such as a Lithium Ion battery (“LIB”). The power source 222 may be removable or form an integrated part of the aerosol provision device 202. The power source 222 may be recharged through connection of the aerosol provision device 202 to an external power supply (such as mains power) through an associated connection port, such as a USB port (not shown) or via a suitable wireless receiver (not shown).

The control circuitry 223 may be suitably configured or programmed to control the operation of the aerosol provision device 202 to provide certain operating functions of the aerosol provision device 202. The control circuitry 223 may be considered to logically comprise various sub-units or circuitry elements associated with different aspects of the operation of the aerosol provision devices 202. For example, the control circuitry 223 may comprise a logical sub-unit for controlling the recharging of the power source 222. Additionally, the control circuitry 223 may comprise a logical sub-unit for communication e.g. to facilitate data transfer from or to the aerosol provision device 202. However, a primary function of the control circuitry 223 is to control the aerosolization of aerosol generating material, as described in more detail below.

It will be appreciated the functionality of the control circuitry 223 can be provided in various different ways, for example using one or more suitably programmed programmable computer(s) and/or one or more suitably configured application-specific integrated circuit(s), circuitry, chip(s) or chipset(s) configured to provide the desired functionality. The control circuitry 223 may be connected to the power supply 222 and may receive power from the power source 222 and may be configured to distribute or control the power supply to other components of the aerosol provision device 202.

The aerosol provision device 202 may further comprises a reception region 225 which is arranged to receive an aerosol generating article 204. The reception region 225 may be suitable sized to removably receive the aerosol generating article 204 therein. The aerosol generating article 204 may comprise a carrier component or substrate (e.g. card) 242, one or more susceptors or a susceptor layer and aerosol generating material 244 provided on the one or more susceptors or the susceptor layer. According to an arrangement a single susceptor layer may be provided wherein the single susceptor layer comprises an aluminum foil layer or a metallic foil layer.

The aerosol provision device 202 may comprise a lid portion and a base portion which are configured to engage with each other. A securing mechanism may be provided in order to secure the lid portion to the base portion. Various configurations for the lid and base portions are contemplated. The aerosol provision device 202 may comprise a hinged door or removable part of the outer housing 221 to permit access to the reception region 225 such that a user may insert and/or remove an aerosol generating article 204 into/from the reception region 225. The hinged door or removable part of the outer housing 221 may also act to retain the aerosol generating article 204 within the reception region 225 when closed.

When an aerosol generating article 204 is exhausted or the user simply wishes to switch to a different aerosol generating article 204, the aerosol generating article 204 may be removed from the aerosol provision device 202 and a replacement aerosol generating article 204 may be positioned in the reception region 225 in its place.

The aerosol provision device 202 may include a permanent opening that communicates with the reception region 225 through which the aerosol generating article 204 can be inserted into the reception region 225. In such implementations, a retaining mechanism for retaining the aerosol generating article 204 within the reception region 225 of the aerosol provision device 202 may be provided.

The retaining mechanism may comprise a securing mechanism configured to engage the lid portion with the base portion so as to hold in position, in use, an aerosol generating article 204 so as to prevent relative movement of the aerosol generating article 204. For example, the lid portion and the base portion may be configured so as to hold the aerosol generating article 204 in position in between the lid portion and the base portion.

FIG. 2 illustrates a schematic view of a portion of an aerosol provision device 202 according to an arrangement. The aerosol provision device 202 is shown with an aerosol generating article 204 which comprises aerosol generating material located within the aerosol provision device 202. The combination of the aerosol provision device 202 and the aerosol generating article 204 together form an aerosol provision system.

The aerosol generating article 204 has an first or upper surface 112 upon which aerosol generating material 244 may be arranged. The aerosol generating article 204 may include a carrier layer 242 (which may be referred to herein as a carrier or a substrate supporting layer) and a susceptor layer on which the aerosol generating material 244 may be disposed. The aerosol generating material 244 may be arranged as a plurality of doses of the aerosol generating material. The aerosol generating article 204 has a second or lower surface 116 on the opposite side to the first or upper surface 112. The first or upper surface 112 and/or the second or lower surface 116 may be smooth or rough.

According to various embodiments a first surface located within the aerosol provision device is monitored and a determination is made as to the cleanliness state or predicted cleanliness state of the first surface. It is envisaged that the first surface which is monitored forms part of the aerosol provision device 202 and not the aerosol generating article 204. Accordingly, it is not envisaged that the cleanliness state or predicted cleanliness state of either the first or upper surface 112 or the second or lower surface 116 of the aerosol generating article 204 is monitored or determined and hence the first surface which is monitored is not the first (or upper) or second (or lower) surface 112, 116 of the aerosol generating article 204.

The aerosol provision device 202 may comprise one or more induction heating elements 224a arranged to face the second surface 116 of the aerosol generating article 204. The one or more induction heating elements 224a may be arranged to transfer energy from a power source, such as a battery (not shown), to the aerosol generating material 244 in order to generate aerosol from the aerosol generating material 244. However, according to various embodiments an isolation layer, which may comprise a thermal isolation layer, may be provided on a first or upper surface of the one or more induction heating elements 224a.

The aerosol provision device 202 according to an arrangement may have a movement mechanism 130 arranged to move the aerosol generating article 204, and in particular portions (or, in some cases, doses) of aerosol generating material 244. The portions of aerosol generating material 244 may be rotated relative to one or more inductive heating element(s) or induction coil(s) 224a such that portions of the aerosol generating material 244 are presented, in this case individually, to the inductive heating element(s) or induction coil(s) 224a. In the arrangement shown in FIG. 2 the inductive heating element 224a may comprise an induction coil and the aerosol generating article 204 includes a layer that acts as a susceptor.

The aerosol provision device 202 may be arranged such that at least one dose of the aerosol generating material 244 is rotated around an axis A at an angle θ to the second surface 116. Control circuitry 223 may be configured to actuate both the inductive heating element(s) or induction coil(s) 224a and the movement mechanism 130 such that the aerosol generating article 204 rotates so as to align a discrete portion of aerosol generating material 244 in close proximity to the inductive heating element(s) or induction coil(s) 224a. The aerosol generating article 204 may be substantially flat or planar. The carrier layer 242 of the aerosol generating article 204 may be formed of partially or entirely of paper or card.

The aerosol generating article 204 shown in FIG. 2 comprises five doses (or portions) of aerosol generating material 244. In other examples, the aerosol generating article 204 may have more or fewer doses of aerosol generating material 244. In some examples, the aerosol generating article 204 may have the doses of aerosol generating material 244 arranged in discrete doses as shown in FIG. 2.

In other examples, the doses may be in the form of a disc, which may be continuous or discontinuous in the circumferential direction of the aerosol generating article 204. In still other examples, the doses may be in the form of an annulus, a ring or any other shape. The aerosol generating article 204 may or may not have a rotationally symmetrical distribution of doses on the first surface 112 about the axis A. A symmetrical distribution of doses would enable equivalently positioned doses (within the rotationally symmetrical distribution) to receive an equivalent heating profile from the inductive heating element(s) or induction coil(s) 224a upon rotation about the axis A, if desired.

The aerosol generating article 204 of the present example includes aerosol generating material 244 disposed on a susceptor layer of the aerosol generating article 204. However, in other implementations, the aerosol generating article 204 may be formed exclusively of aerosol generating material 244; that is, in some implementations, the aerosol generating article 204 may consist entirely of aerosol generating material 244. In this example, one or more susceptor elements may be provided as part of the aerosol generating device 204.

The aerosol generating article 204 may have a layered structure and may be formed from a plurality of materials. In one example, the aerosol generating article 204 may have a layer formed from at least one of a thermally conductive material, an inductive material, a permeable material or an impermeable material.

In some implementations, the carrier layer 242 or the substrate may be, or may include, a metallic element that is arranged to be heated by a varying magnetic field and hence may act as a susceptor layer. In such implementations, the inductive heating element 224a may include one or more induction coils 224a, which, when energised, cause heating within the metallic element of the aerosol generating article 204. The degree of heating may be affected by the distance between the metallic element or susceptor layer and the induction coil 224a.

The arrangement shown in FIG. 2 operates by indexing (or moving) the plurality of doses of aerosol generating material 244 relative to the inductive heating element(s) or induction coil(s) 224a. While this arrangement of FIG. 2 may have a slight increase in the complexity of the movement mechanism 130 to provide movement to the aerosol generating article 204, there are benefits to be had by virtue that the aerosol provision device 204 may comprise a single inductive heating element 224a which is used to heat a plurality of portions of aerosol generating material 244. It will be understood that a single heating element 224a requires a single control mechanism (such as control circuitry 223) whereas a plurality of heaters may each require separate control mechanisms. As such, this arrangement can reduce the cost and control complexity in relation to the operation and control of the inductive heating element 224a.

The shape of the aerosol provision device 202 may be cigarette-shape (longer in one dimension than the other two) or may be other shapes. In an example, the aerosol provision device 202 may have a shape that is longer in two dimensions than the other one, for example like a compact-disc player or the like. Alternatively, the shape may be any shape that can suitably house the aerosol generating article 204, one or more inductive heating element(s) or induction coil(s) 224a and the movement mechanism 130.

The aerosol generating article 204 may comprise a carrier component 242 which may be formed of card. The carrier component 422 may form the majority of the aerosol generating article 204 and may act as a base for one or more susceptors or a susceptor layer with aerosol generating material 244 provided or deposited thereupon. The carrier component 242 may be broadly cuboidal in form. The carrier component 242 may have a length of 30-80 mm, a width 7-25 mm and a thickness 0.2 mm. However, it should be appreciated that other arrangements are contemplated wherein the carrier component 242 may have different dimensions as appropriate. In some implementations, the carrier component 242 may comprise one or more protrusions extending in the length and/or width directions of the carrier component 242 to help facilitate handling of the aerosol generating article 204 by the user.

The aerosol generating article 204 may comprise a plurality of discrete portions of aerosol generating material 244 disposed on a surface of the carrier component 242. According to an arrangement the aerosol generating article 204 may comprise two, three, four, five, six, seven, eight, nine, ten, eleven, twelve, thirteen, fourteen, fifteen or more than fifteen discrete portions of aerosol generating material 244.

The discrete portions of aerosol generating material 244 may be disposed in a n×m array. However, it should be appreciated that in other implementations a greater or lesser number of discrete portions may be provided and/or the portions may be disposed in a different format array (e.g. a one by six array). Other arrangements are contemplated wherein the aerosol generating article 204 comprises a disc and separate portions of aerosol generating material 244 are provided in separate segments of the disc.

The aerosol generating material 244 may be disposed at discrete separate locations on a single surface of the component carrier 242. The discrete portions of aerosol generating material 244 are shown as having a circular footprint, although it should be appreciated that the discrete portions of aerosol generating material 244 may take any other footprint, such as square, trapezoidal or rectangular, as appropriate. The discrete portions of aerosol generating material 244 may have a diameter d and a thickness ta. The thickness ta of the discrete portions may take any suitable value, for example the thickness ta may be in the range of 50 μm to 1.5 mm. In some arrangements, the thickness ta may be from about 50 μm to about 200 μm, or about 50 μm to about 100 μm, or about 60 μm to about 90 μm, suitably about 77 μm. In other arrangements, the thickness ta may be greater than 200 μm e.g. from about 50 μm to about 400 μm, or to about 1 mm, or to about 1.5 mm.

The discrete portions of aerosol generating material 244 may be arranged separate from one another such that each of the discrete portions may be energised (e.g. heated) individually or selectively to produce an aerosol.

The aerosol generating article 204 may comprise a plurality of portions of aerosol generating material 244 all formed from the same aerosol generating material. Alternatively, the aerosol generating article 204 may comprise a plurality of portions of aerosol generating material 244 where at least two portions are formed from different aerosol generating materials.

The one or more inductive heating element(s) or induction coil(s) 224a may be positioned such that a surface of the one or more inductive heating element(s) or induction coil(s) 224a forms a part of the surface of the reception region 225. That is, an outer, first or upper surface of the one or more inductive heating element(s) or induction coil(s) 224a is flush with the inner surface of the reception region 225. However, according to various embodiments an isolation layer, particularly a thermal isolation layer, may be provided on a surface of the one or more inductive heating element(s) or induction coil(s) 224a so that the isolation layer forms a part of the surface of the reception region 225.

The one or more inductive heating element(s) or induction coil(s) 224a may be arranged such that, when the aerosol generating article 204 is received in the reception region 225, each inductive heating element or induction coil 224a aligns with a corresponding discrete portion of aerosol generating material 244. For example, if six inductive heating elements or induction coils 224a are arranged in a two by three array then the aerosol generating article 204 may comprise a two by three array of the six discrete portions of aerosol generating material 244. However, as discussed above, the number of inductive heating elements or induction coils 224a may be different in different implementations. For example, according to various arrangements 1, 2, 3, 4, 5, 6, 7, 8, 9, 10, 11, 12, 13, 14, 15, 16, 17, 18, 19 or 20 separate inductive heating elements or inductions coils 224a may be provided.

Each of the inductive heating element(s) or induction coil(s) 224a can be individually activated to heat a corresponding portion of aerosol generating material 244. While the inductive heating elements or induction coils 224a are shown flush with the inner surface of the reception region 225, in other implementations the inductive heating elements or induction coils 224a may protrude into the reception region 225. However, according to various embodiments an isolation layer, particularly a thermal isolation layer, may be provided on a surface of the one or more inductive heating element(s) or induction coil(s) 224a so that the isolation layer forms a part of the surface of the reception region 225.

The reception region 225 may comprise components which apply a force to the surface of the aerosol generating article 204 so as to press the aerosol generating article 204 onto a surface of the aerosol provision device 202 to prevent relative movement of the aerosol generating article 204. As will be understood, the lid portion of the aerosol provision device 202 may be configured to engage with the base portion via e.g. a securing mechanism, such that the lid portion and/or the base portion comprise components which apply a force to the surface of the aerosol generating article 204 so as to secure the aerosol generating article 204 against relative movement.

Additionally or alternatively, the one or more inductive heater elements or induction coils 224a may be configured to move in a direction towards or away from the aerosol generating article 204, and may be pressed into the surface of carrier component 242 that does not comprise the aerosol generating material 244.

In arrangements wherein the aerosol generating article 204 is configured to move in a specified or desired direction relative to the one or more inductive heater elements or induction coils 224a, the securing mechanism may be configured to engage the lid portion with the base portion so as to hold in position the aerosol generating article 204 to prevent relative movement of the aerosol generating article 204 thereby preventing relative movement in a direction other than in the specified or desired direction.

For example, in arrangements wherein the aerosol generating article 204 is configured to rotate about a rotation axis relative to the one or more inductive heater elements or induction coils 224a so as to present to the one or more inductive heater elements or induction coils 224a a fresh region of aerosol generating material on the aerosol generating article 204, the securing mechanism may be configured to engage the lid portion with the base portion so as to still enable the aerosol generating article 204 to be rotated relative to the one or more inductive heater elements or induction coils 224a whilst preventing relative movement of the aerosol generating article 204 in a direction other than rotation about the rotation axis.

The one or more induction coils 224a may be provided adjacent the reception region 225 and may comprise generally flat coils arranged such that the rotational axis about which a given coil is wound extends into the reception region 225 and is broadly perpendicular to the plane of the carrier component 242 of the aerosol generating article 204.

The control circuitry 223 may comprise a mechanism to generate an alternating current which is passed to any one or more of the induction coils 224a. The alternating current generates an alternating magnetic field which in turn causes the corresponding susceptor(s) or a portion of a susceptor layer to heat up. The heat generated by the susceptor(s) or a portion of a susceptor layer is transferred to the portions of aerosol generating material 244 accordingly.

Various arrangements have been described wherein one or more susceptors are provided as part of aerosol generating article 204. However, other arrangements are contemplated wherein one or more susceptors are located within or as part of the aerosol provision device 202. For example, one or more susceptors may be provided above the one or more induction coils 224a and may be arranged such that the one or more susceptors contact the second or lower surface of the carrier component 242. According to various arrangements an isolation layer may be provided between at least a portion of the one or more susceptors and the one or more induction coils 224a. Furthermore, arrangements are contemplated wherein one or more susceptors may be formed as an array of susceptor elements located in an isolation layer which forms a matrix around the array of susceptor elements. The isolation layer may have a depth or thickness greater than that of the array of susceptor elements. As a result, according to such an arrangement, portions of the susceptor elements and also portions of the isolation layer may contact the second or lower surface of the carrier component 242.

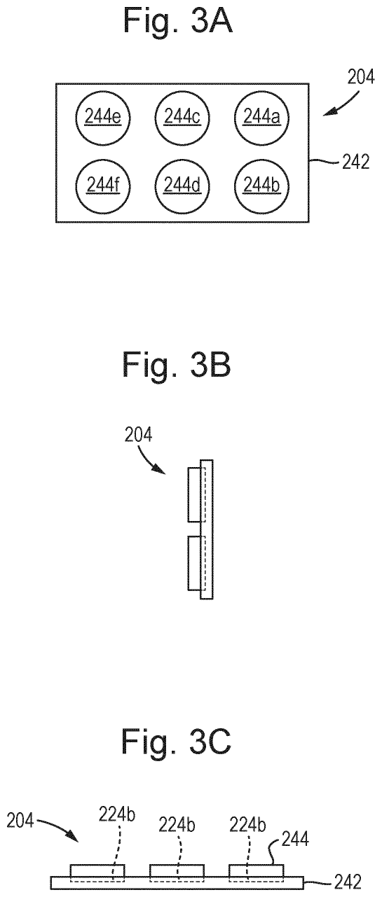

An aerosol generating article 204 for use with the aerosol provision device 202 may comprise a carrier component 242, one or more susceptor elements 224b and one or more portions of aerosol generating material 244a-f as shown and described in more detail with reference to FIGS. 3A-3C.

FIG. 3A shows a top-down view of an aerosol generating article 204 according to an arrangement, FIG. 3B shows an end-on view along the longitudinal (length) axis of the aerosol generating article 204 according to an arrangement and FIG. 3C shows a side-on view along the width axis of the aerosol generating article 204 according to an arrangement.

The one or more susceptor elements 224b may be formed from aluminum foil, although it should be appreciated that other metallic and/or electrically conductive materials may be used in other implementations. As seen in FIG. 3C, the carrier component 242 may comprise a number of susceptor elements 224b which correspond in size and location to the discrete portions of aerosol generating material 244a-f disposed on the surface of the carrier component 242. That is, the susceptor elements 224b may have a similar width and length to the discrete portions of aerosol generating material 244a-f.

The susceptor elements 224b are shown embedded in the carrier component 242. However, in other arrangements, the susceptor elements 224b may be placed or located on the surface of the carrier component 242. According to another arrangement a susceptor may be provided as a single layer substantially covering the carrier component 244. According to an arrangement the aerosol generating article 204 may comprise a substrate or support layer, a single layer of aluminum foil which acts as a susceptor and one or more regions of aerosol generating material 244 deposited upon the aluminum foil susceptor layer.

According to an arrangement an array of induction heating coils 224a may be provided to energise the discrete portions of aerosol generating material 244. However, according to other arrangements a single induction coil 224a may be provided and the aerosol generating article 204 may be configured to move relative to the single induction coil 224a. Accordingly, there may be fewer induction coils 224a than discrete portions of aerosol generating material 244 provided on the carrier component 242 of the aerosol generating article 204, such that relative movement of the aerosol generating article 204 and induction coil(s) 224a is required in order to be able to individually energise each of the discrete portions of aerosol generating material 244.

Alternatively, a single induction coil 224a may be provided and the aerosol generating article 204 may be rotated relative to the single induction coil 224a.

For example, a movable inductive heating element may be provided within the reception region 225 such that the inductive heating element may move relative to the reception region 225. In this way, the movable inductive heating element can be translated (e.g. in the width and length directions of the carrier component 242) such that the inductive heating element 224a can be aligned with respective ones of the discrete portions of aerosol generating material 244.

Although the above has described implementations where discrete, spatially distinct portions of aerosol generating material 244 are deposited on a carrier component 242, it should be appreciated that in other implementations the aerosol generating material 244 may not be provided in discrete, spatially distinct portions but instead be provided as a continuous sheet, film or layer of aerosol generating material 244. In these implementations, certain regions of the sheet of aerosol generating material 244 may be selectively heated to generate aerosol in broadly the same manner as described above. In particular, a region (corresponding to a portion of aerosol generating material) may be defined on the continuous sheet of aerosol generating material 244 based on the dimensions of the one or more inductive heating elements 224a.

Although it has been described above that the heating elements 224a are arranged to provide heat to aerosol generating material 244 (or portions thereof) at an operational temperature at which aerosol is generated from the portion of aerosol generating material 244, in some implementations, the one or more inductive heating elements or induction coils 224a and associated susceptor element(s) may be arranged to pre-heat portions of the aerosol generating material to a pre-heat temperature (which is lower than the operational temperature). At the pre-heat temperature, a lower amount or no aerosol is generated when the portion is heated at the pre-heat temperature. In particular, in some implementations, the control circuitry 223 may be configured to supply power or energy prior to the first predetermined period starting i.e. prior to receiving the signalling signifying a user's intention to inhale aerosol. This may be particularly suitable for relatively thicker portions of aerosol generating material e.g. having thicknesses greater than 400 μm, which require relatively larger amounts of energy to be supplied in order to reach the operational temperature.

It will be appreciated that, whilst each of the one or more inductive heating elements or induction coils 224a may provide the same heating profile to a respective aerosol generating region, one or more of the inductive heating elements or induction coils 224a may instead be configured to provide a different heating profile to different respective aerosol generating regions. For example, aerosol generating regions located further from the mouthpiece 228 may be heated according to a heating profile that generates a greater amount of aerosol than for an aerosol generating region located closer to the mouthpiece 228 which may offset additional loss of aerosol due to condensation along the increased distance of travel, providing a more consistent delivery of aerosol from different aerosol generating regions.

The aerosol provision device 202 may comprise a rotating device configured to rotate, about a rotation axis, the aerosol generating article 204. The rotation device may be configured to rotate the aerosol generating article 204 relative to one or more induction coil(s) 224a so that one or more fresh aerosol generating regions of the aerosol generating article 204 are moved into proximity to the one or more induction coil(s) 224a. A securing mechanism may be configured to enable the aerosol generating article 204 to be rotated relative to the one or more inductions coil(s) 224a whilst preventing relative movement of the aerosol generating article 204 in a direction other than rotation about the rotation axis, such as in the z-direction as indicated in FIG. 1.

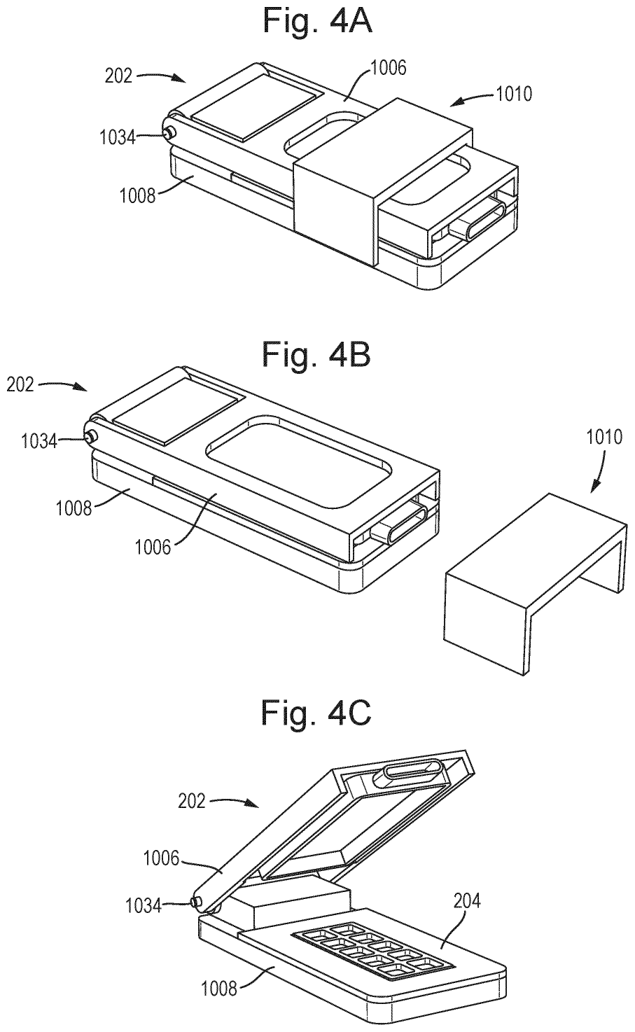

FIG. 4A shows an aerosol provision device according to an arrangement comprising a lid portion 1006 and a base portion 1008. A securing mechanism 1010 may be provided which comprises a clasp such as a slidable clasp configured to clamp the lid portion 1006 of the aerosol provision device 202 to the base portion 1008 so as to engage the lid portion 1006 with the base portion 1008. Alternatively or additionally, the securing mechanism may comprise a rotatable clasp. The lid portion 1006 may pivot about a hinge mechanism 1034.

FIG. 4B shows the securing mechanism 1010 removed and FIG. 4C shows the lid portion 1006 in an open position with an aerosol generating article 204 inserted into or within the aerosol provision device 202.

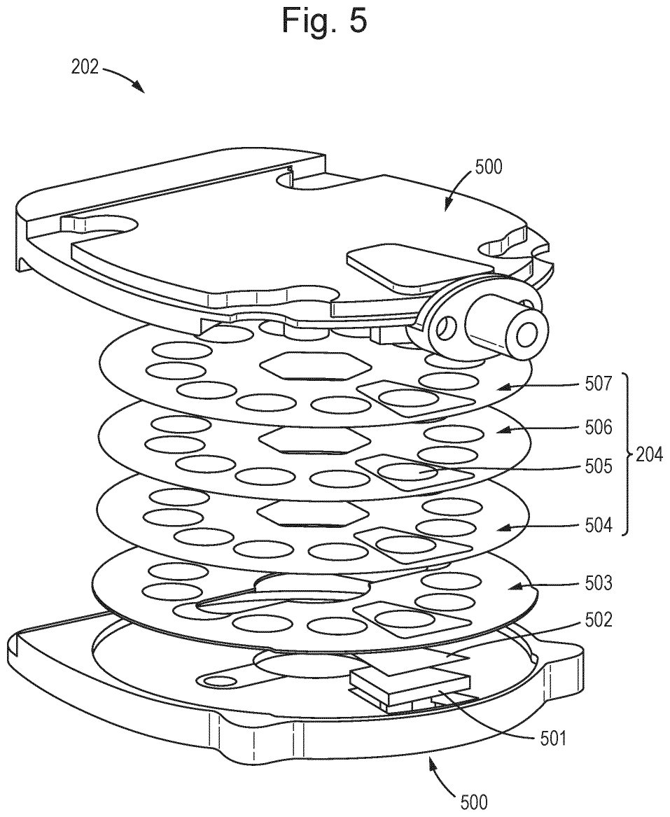

FIG. 5 shows a portion of an aerosol provision device 202 according to an arrangement comprising a component 500 which may comprise an aerosol chamber and a mouthpiece. The aerosol chamber may be arranged to receive aerosol generated from a portion of an aerosol generating article 204 and the aerosol may be onwardly transmitted to the mouthpiece so that the aerosol can be inhaled by a user.

As described above, the component 500 (and in particular the aerosol chamber) may be arranged to contact the aerosol generating article 204. Furthermore, the component 500 may be arranged to press the aerosol generating article down onto a base portion of the aerosol provision device 202. The aerosol generating article 204 may be arranged to contact an isolation layer or first layer 503 when generating aerosol with the result that over a period of time the first or upper surface of the isolation layer or first layer 503 may accumulate dirt. In particular, the first or upper surface of the isolation layer or first layer 503 may, over a period of time, become coated with dust, a greasy deposit from contact with human skin (e.g. sebum as released from sebaceous glands) or aerosol generating material. More generally, the aerosol generating article 204 may be arranged to contact an isolation layer or first layer 503 when generating aerosol with the result that over a period of time a first surface of the isolation layer or first layer 503 may accumulate dirt. In particular, the first surface of the isolation layer or first layer 503 may, over a period of time, become coated with dust, a greasy deposit from contact with human skin (e.g. sebum as released from sebaceous glands) or aerosol generating material.

The isolation layer or first layer 503 may be substantially transparent to a magnetic field emitted by one or more induction coils 501.

An aerosol generating article 204 is shown inserted into the portion of the aerosol provision device 202. The aerosol generating article 204 may comprise a base support layer 504 (which may comprise card), an aluminum foil susceptor layer 506 and a layer of aerosol generating material 507 (e.g. gel). A consumable bed 500 is shown wherein a PCB inductor coil 501 is located within the consumable bed 500. The inductor coil 501 is adhered by an adhesive layer 502 to the rear surface of the isolation layer 503 which may be secured to the consumable bed 500 and is non-rotatable.

As will be understood, according to various arrangements the component 500 may be disengaged from contacting the aerosol generating article 204 thereby enabling the aerosol generating article 204 to be rotated relative to the induction coil 501.

In the arrangement shown in FIG. 5 the induction coil 501 may be arranged to heat a region 505 of a susceptor 506 thereby heating a corresponding region of aerosol generating material provided in the layer 507 comprising aerosol generating material. As a result, a dose of aerosol may be released from the aerosol generating layer 507 and the resulting aerosol may then be captured by an aerosol chamber provided in the component 500. The aerosol may then be onwardly transmitted from the aerosol chamber to a mouthpiece which may also be provided in the component 500.

Once a dose of aerosol has been released, the aerosol generating article 204 may be rotated so that a fresh portion of aerosol generating material is located above the induction coil 501. For example, the aerosol generating article 204 may be rotated 6, 7, 8, 9, 10, 11, 12 or more than 12 times during a session of use.

According to an arrangement an aerosol provision device is disclosed comprising an aerosol generator. The aerosol generator may, for example, comprise one or more induction coils or inductive heating element. A first device is arranged to determine a cleanliness state or a predicted cleanliness state of a first surface located within the aerosol provision device 202. The first device may comprise a controller and the controller may be arranged to determine the number of puffs taken by a user subsequent to a prior cleaning event. The controller may alternatively determine the number of activations of the aerosol generator subsequent to a prior cleaning event or the number of rotations or translations of an aerosol generating article 204 subsequent to a prior cleaning event.

For example, the controller may determine that the user has taken N puffs from the aerosol provision device 202 since the aerosol provision device 202 was last subjected to a cleaning event. Alternatively, the controller may determine that induction coil 501 has been activated N times since the aerosol provision device 202 was last subjected to a cleaning event. According to another arrangement the controller may determine that there have been N rotations or translation of an aerosol generating article 204 within the aerosol provision 202 since the aerosol provision device 202 was last subjected to a cleaning event.

According to various arrangements the controller may determine that a surface of the aerosol provision device has a first cleanliness state indicating that the surface may need cleaning if N is greater than a threshold value. Equally, the controller may determine that a surface of the aerosol provision device has a second cleanliness state indicating that the surface may not need cleaning if N is lower than a threshold value.

According to an arrangement the controller may be arranged to determine a distance or separation between a portion of the aerosol generator and a portion of an aerosol generating article 204 located, in use, within the aerosol provision device 202. For example, the controller may be arranged to sense or determine the separation distance between a first or upper surface of the isolation layer 503 and a second or lower surface of the susceptor layer 506 of an aerosol generating article.

If the separation distance is determined to be above a threshold then this may be indicative that the first or upper surface of the isolation layer 503 has become covered with a deposit of dirt, dust or aerosol generating material and hence that the isolation layer 503 is in need of cleaning.

The controller may also make a determination that a first surface of the aerosol provision device 202 is in need of cleaning by determining whether or not a ramp up time corresponding to the time taken to reach an operational temperature has increased above a threshold. For example, the aerosol provision device 202 may have a desired ramp up time of 1.2 s i.e. it may be desired to be able to heat a portion 505 of the susceptor layer 506 to a temperature of 275° C. or 300° C. within a time of 1.2 s. The controller may be arranged to determine the temperature of the susceptor layer 506 by monitoring the resonance frequency of the one or more induction coils 501. As the temperature of a portion of the susceptor layer 506 layer increases, the resonance frequency of the one or more induction coils 501 may decrease.

If the controller determines that the ramp up time has increased above a threshold (e.g. 1.5 s) then the controller may determine that a first surface of the aerosol provision device 202 such as the first or upper surface of the isolation layer or first layer 503 has a first cleanliness state indicative that the surface needs cleaning in order to maintain optimum operation of the aerosol provision device 202.

Equally, if the controller determines that the ramp up time has not increased above a threshold (e.g. 1.5 s) then the controller may determine that the first surface has a second cleanliness state indicative that the first surface does not need cleaning.

According to various arrangements the cleanliness of the first surface (as monitored or determined by the controller) may comprise a first (i.e. contact) surface between an aerosol generating article and the aerosol provision device. The first (i.e. contact) surface may, for example, comprise a surface of an isolation layer or a surface of a first layer 503. According to various arrangements the first surface may not be intended to come into contact with aerosol generating material 507. For example, as shown in FIG. 5 the first surface may comprise a first or upper surface of the isolation layer 503 which in use contacts a second or lower surface of the base support layer 504.

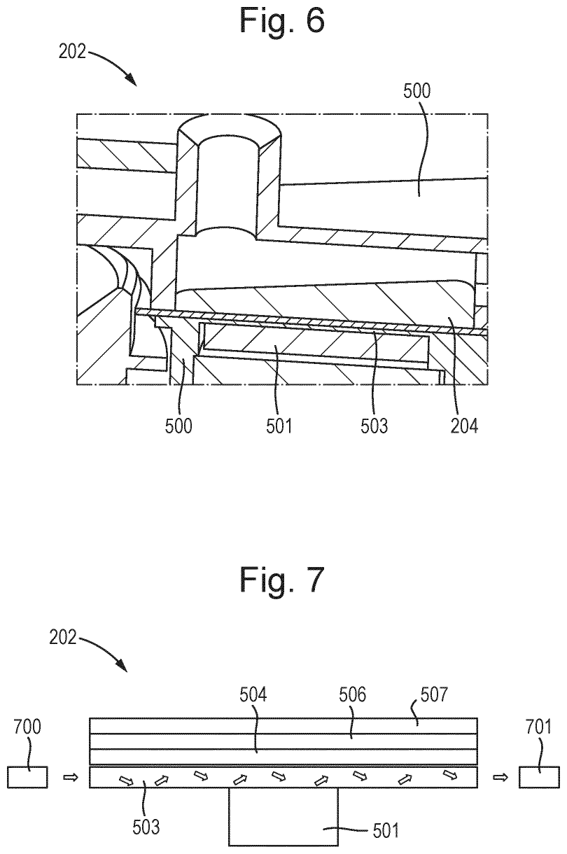

FIG. 6 shows a close up cutaway view of a portion of an aerosol provision device 202 according to an arrangement wherein an aerosol generating article 204 has been inserted into the aerosol provision device 202. The aerosol generating article 204 contacts an isolation layer or first layer 503 which is provided between an induction coil 501 and the aerosol generating article 204.

The isolation layer or first layer 503 may comprise a thermal isolation layer or first layer 503 comprising glass, ceramic or a plastic layer. The isolation layer or first layer 503 may be optically transparent and may have a thermal conductivity of <0.01 W/mK, 0.01-0.05 W/mK, 0.05-0.1 W/mK, 0.1-0.5 W/mK, 0.5-1 W/mK, 1-5 W/mK, 5-10 W/mK, 10-20 W/mK, 20-30 W/mK, 30-40 W/mK and 40-50 W/mK.

FIG. 7 shows an arrangement wherein the cleanliness of an isolation layer or first layer 503 may be determined by emitting electromagnetic radiation from an optical transmitter 700. The electromagnetic radiation is then passed through the isolation layer or first layer 503 which forms an optical waveguide. According to various arrangements the electromagnetic radiation is internally reflected within the isolation layer or first layer 503. The electromagnetic radiation is then arranged to emerge from the isolation layer or first layer 503 and is detected by an optical receiver 701. It will be understood that the efficiency of the internal reflection process within the waveguide will be partly determined by the refractive index of the first or upper surface (or first surface) of the isolation layer or first layer 503. If the first or upper surface (or first surface) of the isolation layer or first layer 503 is dirty due to repeated contact with an aerosol generating article then the deposit of dirt on the first or upper surface (or first surface) of the isolation layer or first layer 503 will effect or alter the refractive index of the first or upper surface (or first surface) of the isolation layer or first layer 503. As a result, the refractive index of the first or upper surface (or first surface) of the isolation layer or first layer 503 may vary over time. For example, the refractive index of the isolation layer or first layer 503 for electromagnetic radiation having a wavelength of λ nm may be n1 and this may be altered by dirt to a value n2, wherein either n2>n1 or n2<n1.

Accordingly, arrangements are disclosed wherein a first device is arranged to determine a cleanliness state or a predicted cleanliness state of a first surface located within the aerosol provision device 202. The first device may comprise an optical device which may comprise an optical transmitter 700 and an optical detector 701. The optical transmitter 700 may be arranged to transmit electromagnetic radiation which is at least partially internally reflected within the isolation layer or first layer 503 and which is then detected by the optical detector 701.

Arrangements are contemplated wherein the aerosol provision device 202 may further comprise a device which is arranged to inform a user of the cleanliness state or predicted cleanliness state of the first surface. The device, may for example, comprise an indicator such as a user display or light arrangement.

The aerosol provision device 202 may further comprise a device arranged to advise a user to perform a cleaning routine. For example, if the first device determines that a first surface of the aerosol provision device 202 is potentially in need of cleaning, then this may be communicated to a user by, for example, a visual warning or indication (e.g. on a user display) and/or by haptic feedback prior to, during or after a session of use.

The optical device may further comprise a processor for determining an internal reflectance angle. According to an arrangement a change in the internal reflectance angle may be indicative of a changed (e.g. lowered) cleanliness state.

According to an arrangement the isolation layer or first layer 503 may be planar so as to form a planar optical waveguide. The planar optical waveguide may comprise an entrance face, a waveguiding portion having a longitudinal direction and an exit face, wherein the entrance face and/or the exit face are arranged in a plane which is orthogonal to the longitudinal direction. Light or electromagnetic radiation may be transmitted through the isolation layer or first layer 503. The optical transmitter 700 may be located in a lid portion or base portion of the aerosol provision device 202. The optical receiver 701 may be located in a lid portion or base portion of the aerosol provision device 202.

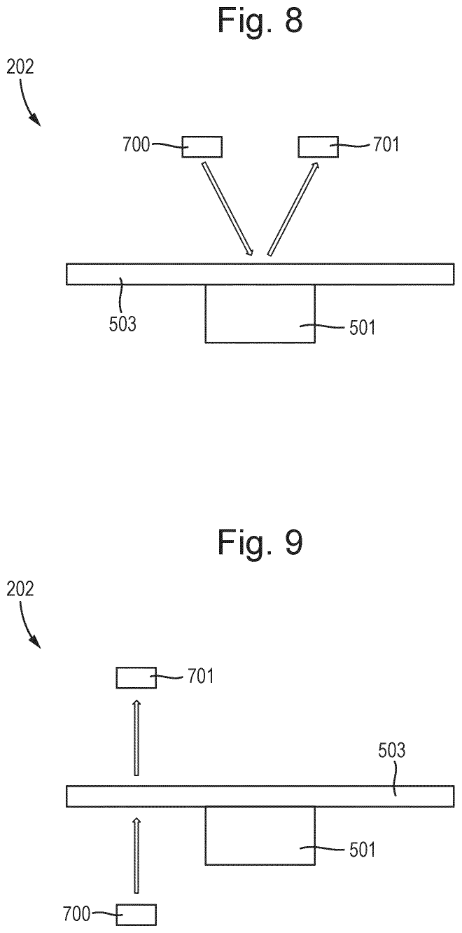

FIG. 8 shows another arrangement wherein the cleanliness of an isolation layer or first layer 503 may be determined by reflecting electromagnetic radiation off a first or upper surface (or first surface) of the isolation layer or first layer 503. If the first or upper surface (or first surface) of the isolation layer or first layer 503 is dirty due to repeated contact with an aerosol generating article then the deposit of dirt on the first or upper surface (or first surface) of the isolation layer or first layer 503 will effect or alter the refractive index of the first or upper surface (or first surface) of the isolation layer or first layer 503. As a result, the refractive index of the first or upper surface (or first surface) of the isolation layer or first layer 503 may vary over time. For example, the refractive index of the isolation layer or first layer 503 for electromagnetic radiation having a wavelength of A nm may be n1 and this may be altered by dirt to a value n2, wherein either n2>n1 or n2<n1.

FIG. 9 shows another arrangement wherein the cleanliness of an isolation layer or first layer is determined by transmitting electromagnetic radiation through the isolation layer or first layer 503 in a direction orthogonal to the plane of the isolation layer or first layer 503. The electromagnetic radiation may be emitted by an optical transmitter 700 and detected by an optical detector 701.

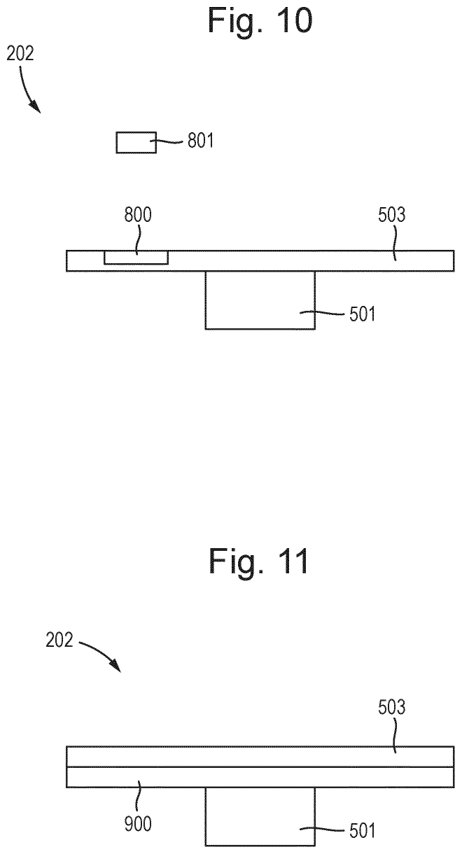

FIG. 10 shows another arrangement wherein the cleanliness of an isolation layer or first layer 503 may be determined by using an imaging device 801 to view optical markings 800 provided in or on the isolation layer or first layer 503.

A portion of the aerosol provision device 202 may further comprise a transparent or translucent isolation layer or first layer having one or more optical markings. The transparent or translucent isolation layer or first layer may comprise a first surface which is desired to be maintained clean. According to another arrangement an optical device may be arranged to interrogate a barcode or another optical marking provided on an portion of an aerosol generating article 204. According to this embodiment a first device may be arranged to determine a cleanliness state or a predicted cleanliness state of a first surface located within the aerosol provision device 202, wherein the first surface comprises the portion of the isolation layer or first layer 503 which includes the optical markings 800.

FIG. 11 shows a further arrangement wherein if the cleanliness of an isolation layer or first layer 503 is determined to be relatively poor then a heater 900 may be operated in order to heat the isolation layer or first layer 503 in order to clean the surface of the isolation layer or first layer 503. Accordingly, an arrangement is disclosed wherein the aerosol generator comprises a heater 900 and wherein if it is determined that a first surface of the aerosol provision device 202 has a cleanliness state below a threshold then the heater 900 may be activated in order to clean the first surface. In the arrangement shown in FIG. 11 the heater 900 is located below the isolation layer or first layer 503. However, other arrangements are contemplated wherein the heater 900 may be located in other locations such as above the isolation surface or first layer 503 or around a perimeter of the isolation layer or first layer 503.

According to various embodiments an aerosol provision device is provided comprising an aerosol chamber which is moveable between a first position wherein the aerosol chamber is in contact with an aerosol generating article and a second position wherein the aerosol chamber is not in contact with an aerosol generating article. A first mechanism may be arranged to move the aerosol chamber between the first and second positions. According to various embodiments the aerosol generating article may comprise a substantially circular or oval substrate having a first surface and a second surface. The substrate may, for example, comprise paper, card or aluminum foil. Other embodiments are contemplated wherein the substrate may comprise multiple layers arranged in a sandwich manner. For example, the substrate may comprise a paper or card substrate having a first aluminum foil layer arranged on a first surface and a second aluminum foil layer arranged on a second surface.

The aerosol generating article may comprise either an open or a closed type of consumable. For example, it will be understood that an open consumable is a type of consumable comprising aerosol generating article wherein the aerosol generating material is provided on one or more outer or outermost surfaces of the aerosol generating article. By contrast, it will be understood that a closed type of consumable comprises an aerosol generating article wherein aerosol generating material is not provided on an outer or an outermost surface of the consumable but rather is provided on one or more internal surfaces. For example, according to various embodiments a closed consumable may be provided wherein one or both outer or outermost surface(s) of the aerosol generating article comprise a gas impermeable layer such as a plastic or other material. For example, embodiments are contemplated wherein an aerosol generating article is provided comprising an innermost substrate having one or more layers of aerosol generating material provided on one or both sides of the substrate and wherein the aerosol generating article is encapsulated or otherwise housed within a housing which is made from a material which is gas impermeable. A closed type of consumable may comprise a housing having an air inlet and an aerosol outlet. The aerosol outlet may comprise a mouthpiece.

According to various embodiments the aerosol generating article may have a length (L), width (W) and thickness (T), wherein the length (L) of the aerosol generating article is greater than the width (W) and/or the thickness (T). The aerosol generating article may have a longitudinal axis and may have a first airflow input end and a second airflow output end. For example, the aerosol generating article may comprise a prism having a first end face and a second end face. The first end face may comprise a region wherein air enters the aerosol generating article in use and the second end face may comprise a region wherein aerosol generated within the aerosol generating article exits the aerosol generating article in use.

Embodiments are contemplated wherein the second end face further comprises a mouthpiece. For example, the aerosol generating article may comprise a distal end (via which air may be arranged to enter the aerosol generating article) and a proximal end (which may comprise a mouthpiece and wherein a user may draw aerosol generated within the aerosol generating article).

According to various embodiments aerosol generating material may be provided on either a first surface and/or a second surface of a substrate. For example, an aerosol generating article may be provided which is either single or double sided. A single sided aerosol generating article may be activated by a single array of heating elements. A double sided aerosol generating article may be activated by a double array of heating elements which in use are provided on both sides of the aerosol generating article.

Embodiments are contemplated wherein the aerosol generating article may be rotated and/or translated relative to one or more aerosol generators. The one or more aerosol generators may comprise, for example, a single aerosol generator or alternatively a plurality of aerosol generators may be arranged, for example, in an array. Embodiments are contemplated wherein aerosol generators may be provided in a n×m array, wherein n=2, 3, 4, 5, 6, 7, 8, 9, 10 or >10 and wherein m=2, 3, 4, 5, 6, 7, 8, 9, 10 or >10. For example, aerosol generators may be provided in a 2×2 array, a 2×3 array, a 2×4 array, a 2×5 array, a 2×6 array, a 2×7 array, a 2×8 array, a 2×9 array or a 2×10 array.

According to various embodiments the one or more aerosol generators may comprise one or more resistive heaters or resistive heating elements. According to other embodiments the one or more aerosol generators may comprise one or more inductive heaters or inductive heating elements. Embodiments are also contemplated wherein a plurality of resistive and inductive heating elements may be provided.

The aerosol generating article may be arranged to be rotated and/or translated relative to one or more aerosol generators so that the aerosol generating article is located adjacent the one or more aerosol generators and is heated from one side only. Alternatively, the aerosol generating article may be arranged to be rotated and/or translated relative to one or more aerosol generators so that the aerosol generating article is inserted between a first set of aerosol generators and a second set of aerosol generators. According to such an embodiment the aerosol generating article may be arranged to be heated either simultaneously or sequentially from two opposed sides.

Embodiments are also contemplated wherein the aerosol generating article may be prism shaped. For example, the aerosol generating article may comprise a triangular prism, a square shaped prism or a cylindrical prism. For example, the aerosol generating article may comprise a cylindrical aerosol generating article. The aerosol generating article may be rotated and/or translated relative to one or more aerosol generators. For example, the aerosol provision device may comprise a cavity into which a prismatic or cylindrical shaped aerosol generating article may be inserted. A matrix, strip or an array of aerosol generators may be provided at one or more locations around or along the cavity. The aerosol generating article may then be rotated and/or translated relative to the aerosol generators so that different portions of the aerosol generating article may be sequentially or progressively heated or otherwise accessed.

Embodiments are contemplated wherein an aerosol generating article may be translated relative to one of more aerosol generators. For example, the aerosol generating article may comprise a plurality of portions of aerosol generating material and the aerosol generating article may be translated in a longitudinal direction so that a plurality of separate portions of aerosol generating material may be activated or otherwise heated in series or sequentially.

Further embodiments are contemplated wherein the aerosol generating article may comprise a cylinder or more generally a prism. A plurality of aerosol generators may be arranged around or about the cylindrical or prismatic shaped aerosol generating article. It is contemplated that the aerosol generating article may be rotated within a static array of aerosol generators. Alternatively, the aerosol generating article may remain static and a plurality of aerosol generators may be rotated relative to the aerosol generating article. A yet further embodiment is contemplated wherein both the aerosol generating article and one or more aerosol generators are movable. For example, the aerosol generating article may be rotated and/or translated at a first speed v1 and one or more aerosol generators may be rotated and/or translated at a second speed v2. Embodiments are contemplated wherein in a mode of operation v1>v2. Embodiments are contemplated wherein in a mode of operation v1=v2. Embodiments are also contemplated wherein in a mode of operation v1<v2.

According to various embodiments the aerosol generating article may comprise a flat or planar consumable having a longitudinal axis. The aerosol generating article may be translated in a direction parallel to the longitudinal axis. Other embodiments are contemplated wherein the aerosol generating article comprises a cylindrical consumable having a longitudinal axis. The cylindrical consumable may be rotated about the longitudinal and/or may be translated in a direction parallel to the longitudinal axis. The aerosol generating article may be single side or double sided. A double sided consumable may be heated, in use, from both sides.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol provision device comprising:
an aerosol generator; and
a first device arranged to determine a cleanliness state or a predicted cleanliness state of a first surface located within the aerosol provision device.

2. An aerosol provision device as claimed in claim 1, wherein the aerosol generator comprises one or more induction coils or inductive heating elements.

3. An aerosol provision device as claimed in claim 1, wherein the first surface comprises a contact surface between an aerosol generating article and the aerosol provision device.

4. An aerosol provision device as claimed in claim 1, wherein the first surface comprises a surface of an isolation layer or a first layer.

5. An aerosol provision device as claimed in claim 4, wherein the isolation layer or first layer comprises a thermal isolation layer.

6. (canceled)

7. (canceled)

8. (canceled)

9. (canceled)

10. An aerosol provision device as claimed in claim 1, wherein the first device is arranged to determine:
(i) the number of puffs taken by a user subsequent to a prior cleaning event;
(ii) the number of activations of the aerosol generator subsequent to a prior cleaning event; or
(iii) the number of rotations or translations of an aerosol generating article subsequent to a prior cleaning event.

11. An aerosol provision device as claimed in claim 1, wherein the first device is arranged to determine a distance or separation between a portion of the aerosol generator and a portion of an aerosol generating article located, in use, within the aerosol provision device.

12. An aerosol provision device as claimed in claim 1, wherein the first device is arranged to determine whether a ramp up time corresponding to the time taken to reach an operational temperature has increased above a threshold time.

13. (canceled)

14. (canceled)

15. An aerosol provision device as claimed in claim 1, wherein the first surface comprises a surface of a planar optical waveguide.

16. (canceled)

17. (canceled)

18. (canceled)

19. An aerosol provision device as claimed in claim 1, further comprising an optical transmitter and an optical detector, wherein the optical transmitter is arranged to emit electromagnetic radiation which is either reflected by the first surface or which is transmitted through the first surface and wherein the optical detector is arranged to detect the electromagnetic radiation reflected by or transmitted through the first surface.

20. An aerosol provision device as claimed in claim 1, further comprising a layer having one or more optical markings and an optical device which is arranged to view or interrogate the one or more optical markings, wherein the first surface comprises a surface of the layer having one or more optical markings.

21. An aerosol provision device as claimed in claim 1, further comprising an optical device which is arranged to view or interrogate a barcode, QR code or other optical marking provided on an aerosol generating article.

22. An aerosol provision device as claimed in claim 20, wherein the optical device is arranged to output a signal to the first device and wherein the first device is arranged to determine a cleanliness state or a predicted cleanliness state of the first surface based upon the signal output from the optical device.

23. An aerosol provision device as claimed in claim 1, wherein the first device comprises an imaging device for observing and analyzing an image provided on a component of the aerosol provision device and/or an aerosol generating article, wherein the first device is arranged to determine a cleanliness state of the first surface dependent upon analysis of one or more qualities of the image as observed.

24. An aerosol provision device as claimed in claim 1, further comprising a heater or other cleaning device for cleaning the first surface.

25. An aerosol provision device as claimed in claim 24, wherein if the first device determines that the first surface has a cleanliness state or a predicted cleanliness state above or below a threshold then the first device is arranged to activate the heater or other cleaning device in order to clean the first surface.

26. (canceled)

27. An aerosol provision device as claimed in claim 1, further comprising a device arranged to inform a user of the cleanliness state or predicted cleanliness state as determined by the first device.

28. An aerosol provision device as claimed in claim 1, further comprising a device arranged to advise a user to perform a cleaning routine if the first device determines that the surface has a first cleanliness state.

29. (canceled)

30. An aerosol generating system comprising:
an aerosol provision device as claimed in claim 1; and
an aerosol generating article.

31. (canceled)

32. (canceled)

33. A method of generating an aerosol comprising:
providing an aerosol provision device comprising an aerosol generator, and
determining a cleanliness state or a predicted cleanliness state of a first surface located within the aerosol provision device.
